(19) United States
(12) Patent Application Publication
(10) Pub. No.: US 2024/0078643 A1
(43) Pub. Date: Mar. 7, 2024

(54) SYSTEMS AND METHODS FOR DENOISING MEDICAL IMAGES

(71) Applicant: UNIVERSITY OF SOUTH FLORIDA, Tampa, FL (US)

(72) Inventor: John David Mayfield, Lithia, FL (US)

(21) Appl. No.: 18/456,465

(22) Filed: Aug. 25, 2023

Related U.S. Application Data
(60) Provisional application No. 63/401,040, filed on Aug. 25, 2022.

(51) Int. Cl. G06T 5/00; G06T 5/50

(52) U.S. Cl. CPC G06T 5/002; G06T 5/50; G06T 2207/10081; G06T 2207/10088; G06T 2207/20081; G06T 2207/20216; G06T 2207/30004

(57) ABSTRACT

Image denoising systems and methods to provide light-weight, high quality, and individually denoised images, which facilitate quick and accurate medical diagnosis from medical images. The systems and methods include: obtaining a medical image of a subject; determining a set of noisy patches from the medical image; determine a dictionary based upon the set of noisy patches by learning a sparse representation of the medical image; denoise the set of noisy patches to create a set of denoised patches; denoise the medical image by reconstructing the denoised set of patches into a denoised version of the medical image; and present the denoised version of the medical image for viewing by a user.

### CROSS-REFERENCE TO RELATED APPLICATION

This application claims the benefit of U.S. Provisional Patent Application Ser. No. 63/401,040, filed Aug. 25, 2022, the disclosure of which is hereby incorporated by reference in its entirety, including all figures, tables, appendices, and drawings.

### STATEMENT REGARDING FEDERALLY SPONSORED RESEARCH

Not Applicable.

### BACKGROUND

The diagnosis of certain medical conditions may depend on clinical symptomatology in connection with findings from medical imaging. Noise artifacts in medical imaging is a significant problem to diagnosticians as it can mimic pathology. For example, for diagnosing multiple sclerosis (MS), the McDonald criteria was developed to identify demyelination in the central nervous system on magnetic resonance imaging (MRI). However, patients often become uncomfortable during the lengthy MRI scans and can introduce motion artifacts into the exam, limiting sensitivity of detection of the lesions. As another example, CT pulmonary angiography (CTPA) has become the reference standard for diagnosing pulmonary embolism (PE). However, the effectiveness of such diagnosing methods is limited due to streak artifacts from adjacent hardware and contrast bolus in the vena cavae, or beam hardening from soft tissue attenuation or arm placement.

Denoising algorithms can be computationally expensive, may lose information and/or resolution, and may not translate between different scanners, patient populations, and medical conditions. Further, erroneous results from medical imaging (e.g., a lesion being artifactual) can lead to significant consequences to the patient.

### BRIEF SUMMARY

The present disclosure describes novel image denoising systems and methods. In some embodiments, the denoising systems and methods are personalized to an individual patient, providing improved personalized clinical decision making. Systems and methods according to various embodiments of the present disclosure may provide lean image denoising that learns based upon a patient's individual imaging features, and is fast and portable. Systems and methods according to various embodiments of the present disclosure may be implemented into a picture archiving and communication system (PACS), and may provide real time or near-real time results in a clinical setting. According to various embodiments, systems and methods as described herein can improve the detection rate for pulmonary emboli in suboptimal studies.

The foregoing and other aspects and advantages of the disclosure will appear from the following description. In the description, reference is made to the accompanying drawings which form a part hereof, and in which there is shown by way of illustration an example configuration of the disclosure. Likewise, examples of studies conducted using certain embodiments are discussed. Such configurations and studies do not necessarily represent the full scope of the disclosure, however, and reference is made therefore to the claims and herein for interpreting the scope of the disclosure.

### BRIEF DESCRIPTION OF DRAWINGS

The invention will be better understood and features, aspects, and advantages other than those set forth above will become apparent when consideration is given to the following detailed description thereof. Such detailed description makes reference to the following drawings.

FIG. 1 is a flow diagram of a method for denoising an image, according to aspects of the present disclosure.

FIG. 2 is a block diagram conceptually illustrating a system for denoising an image, according to aspects of the present disclosure.

FIG. 3A is an exemplary CTPA image, according to aspects of the present disclosure.

FIG. 3B is an exemplary dictionary, that was “learned” according to aspects of the present disclosure.

FIGS. 4A and 4B illustrate a noisy CTPA image, denoised image, and noise difference, according to aspects of the present disclosure.

FIGS. 5A and 5B illustrate image denoising of an MRI of a spinal column, according to aspects of the present disclosure.

### DETAILED DESCRIPTION

Before any aspects of the invention are explained in detail, it is to be understood that the invention is not limited in its application to the details of construction and the arrangement of components or steps set forth in the following description or illustrated in the following drawings. The invention is capable of other aspects and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

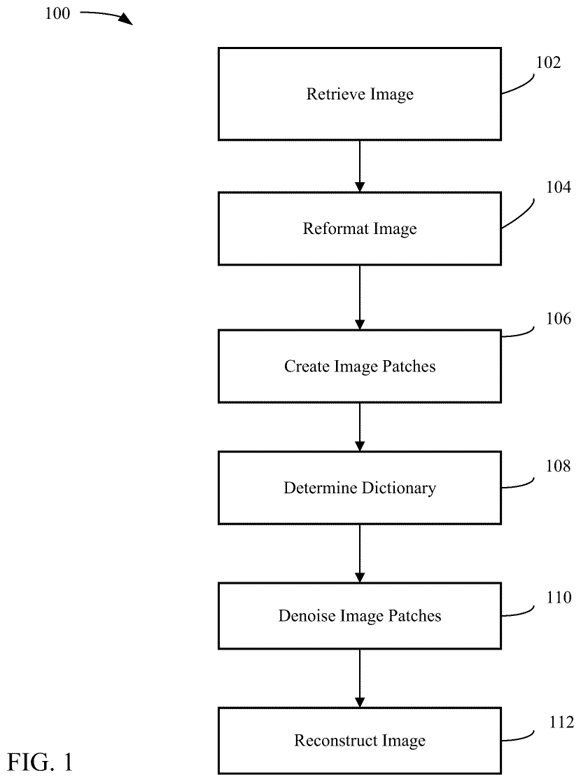

FIG. 1 illustrates an image denoising method 100 according to various embodiments of the present disclosure. The image denoising method 100 may retrieve an image at step 102, for example from a Picture Archiving and Communication System (PACS). The image may be a medical image of any size or resolution, format, color, or grayscale, and the like. And, the image may have been acquired via a number of possible modalities that are susceptible to noise and artifact, including MRI, CT, ultrasound, PET, etc. In some examples, 512×512×3 digital imaging (or any other suitable size) and communications in medicine (DICOM) key images may be acquired and/or received for processing by the method 100.

At step 104, the image may be reformatted to a particular size and color space. In some embodiments, the image may be reformatted to 256×256 pixels with one color channel (e.g. grayscale). In some examples, the received image may be converted to array size 256×256×1 (or any other suitable size).

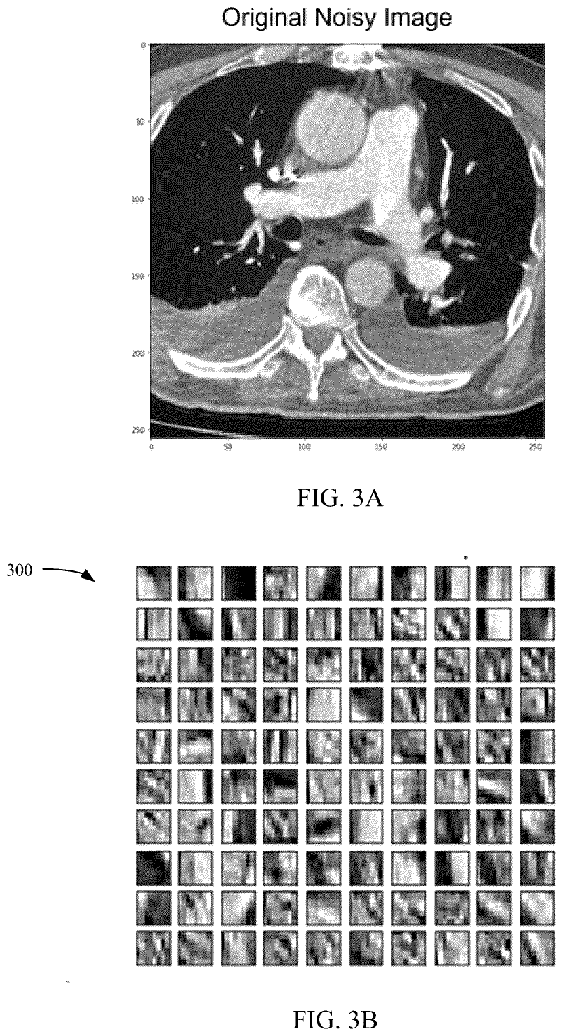

At step 106, a plurality of overlapping image patches may be created from the reformatted image. FIG. 3A illustrates an exemplary reformatted CTPA image. In some embodiments, the reformatted image may be broken up into overlapping patches of 8×8 pixels. The overlap may be configurable. In an exemplary embodiment with a 256×256 pixel reformatted image with 8×8 patches and an overlap of 7 pixels, 62,001 image patches may be created. In some examples, step 106 may perform patch creation by initializing patch size 8×8 (or any other suitable size) and extracting overlapping patches in 2 dimensions for array. In some examples, the patch size may be optimized for all medical imaging whether it is 512×512 or 256×256. In other examples, the patch size may be increased or decreased according to image size/resolution for custom applications.

Once the image patches are created 106, a dictionary may be determined by learning a sparse representation of the image. Orthogonal Matching Pursuit (OMP), Least Angle Regression (LARS), or other algorithms may be used to determine the dictionary. In some embodiments, dictionary determination may be done by Lasso optimization, favoring speed over accuracy, thus using, e.g., L1 norm instead of the L0 norm. For example, a generalized Lasso problem (e.g., Lasso model fit with LARS) may be minimized to provide sparse representation of the image. In some embodiments, a dictionary of “x” features may be extracted over “i” iterations, where both “x” and “i” are tunable. In some examples, the features of “x” and “I” may be user defined features based upon their computational capacity, e.g., lower computational ability may require smaller x and i but would result in slightly slower calculation and subsequent denoising. In an exemplary embodiment, the Lasso problem may be minimized using 500 iterations to provide a dictionary of 100 atoms that sparsely encode the original image patches, for example to provide the dictionary 300 illustrated in FIG. 3B. In some examples, the dictionary can be generated on an image-by-image basis for each image to denoise. In further examples, the dictionary can be generated by iterating for a DICOM stack of images. The generalized estimated noise might not be used for all slices, however, as it stands. Regardless of the approach chosen (whether for an imaging sequence as a whole, or image by image), embodiments described herein are “lightweight” because they do not require pretraining. Thus, any bias does not need to be considered, and the model is flexible for all types of scanners and modalities, regardless of manufacturer. Through this step, a separate noise vector may be incorporated into the dictionary per the patches. This identifies the sparse frequency representation that is unique to the image instead of using, e.g., a generalized DCT dictionary.

In some examples, step 108 may perform dictionary learning with an algorithm as shown below.

Dictionary Learning:

```
n_dict_elements to extract = 100;
alpha = 1;
iterations = 500;
batches = 3
transformation = “Orthogonal Matching Pursuit”;
for i patches:
  Input: noisy patch y, Dictionary A, Support S
  Initialize: k = 0, \hat{x}₀ = 0, r₀ = b− Ax₀, S₀ = Ø;
  For k = k + 1;
    $\text{compute:} E ( i ) = {min}_{z} {‖ {za}_{i} - {r}_{k - 1} ‖}_{2}^{2} , 1 \leq i \leq m ;$
    select i₀ s.t. ∀ 1 ≤ i ≤ m, E(i₀) ≤ E(i) where i₀ = argmax|Aⱼ^{T}rⁱ|;
    update Sₖ : Sₖ₋₁ ∪ {i₀};
    ${\hat{x}}_{k} = {min}_{x} {‖ Ax - b ‖}_{2}^{2} s . t . Supp \{ x \} = {S}_{k} ;$
    update r_{k :} rₖ = b − Axₖ;
  if ||rₖ||₂² ≤ ϵ;
    stop;
  else:
    k = k + 1;
  for patches:
    Fit to extracted patches by minimization of LASSO problem via
    LARS:
  $Z = {min}_{w} \frac{1}{2 N} {‖ y - Xw ‖}_{2}^{2} + α {‖ w ‖}_{1}$
```

In the algorithm shown above, k denotes an iterative variable of any integer value, \hat{x}₀ is the updated signal for each iteration, r₀ is the residual error term that describes the signal difference between the original noisy image, b, and the estimated denoised image for each iteration calculated by the Dictionary, A, and the sparse signal representation, x₀. The Support, S, is a holding bin for the sparsest vectors determined by each iteration. This is continually updated to minimize the error, E, until the resultant sparse dictionary is created which is learned from the individual image and now represented as an updated Dictionary. This Dictionary is used to carry out subsequent singular value decomposition (SVD).

Next, at step 110, the image patches are denoised. In some embodiments, OMP may be used to approximate the denoised patches using a tunable parameter that represents the number of nonzero coefficients mandated for the OMP algorithm. In some embodiments, LARS may be used to approximate the denoised patches using a similar tunable parameter. The L0 norm may be used to provide the sparsest solution.

In some examples, step 110 may perform the patch denoising with an algorithm as shown below.

Denoise patches:

```
Initialize: noisy image Y, learned dictionary D, number of training iteration j, Language multiplier
λ;
Extract patches:
Initialize: n_nonzero_coefficients = N, reconstructions = Ø, set X = Y;
For i patches:
  Input: noisy patch y, Learned dictionary D, Support S;
  Initialize: i = 0, j = 0, \hat{x}₀ = 0, r₀ = b− Ax₀, S₀ = Ø;
  for ∀ᵢⱼ:
    $\text{compute:} {min}_{{a}_{i j}} λ ‖ Y - X ‖ + {\sum }_{ij} {u}_{i j} {‖ {a}_{i j} ‖}_{0} + {\sum }_{ij} {‖ {Da}_{i j} - {R}_{i j} X ‖}_{2}^{2}$
    set: Eₗ = {aᵢⱼ(l)}_{{i,j}∈w}_{ₗ};
    apply: SVD decomposition Eₗ= UΔV^{T};
    update: columns of U with updated dictionary column d̅ₗ;
    update: coefficient values {aᵢⱼ(l)}_{{i,j}∈w}_{ₗ} for values of V multiplied by Δ(1,1)
```

In the algorithm above, the resultant learned dictionary, D, from the previous step is used to iteratively denoise each patch. More specifically, the final step of SVD is to calculate a low-rank matrix which represents the original matrix (patch) in k iterations. In some examples, matrices U and V are orthonormal. The result is a completed denoised patch which will subsequently be recombined.

In some embodiments, in step 110, the sparse dictionary is used to denoise the final image, which was originally an L1 estimation, but now requiring only 1 or 2 or the sparsification factor. The dictionary, used to do the denoising, was built from a loosely sparse frequency distribution of the image's noise and pixel intensities. The dictionary is then incorporated into the sparsest optimization of the image using OMP as the final step where the noise is separated off and the resultant denoised patches are recombined.

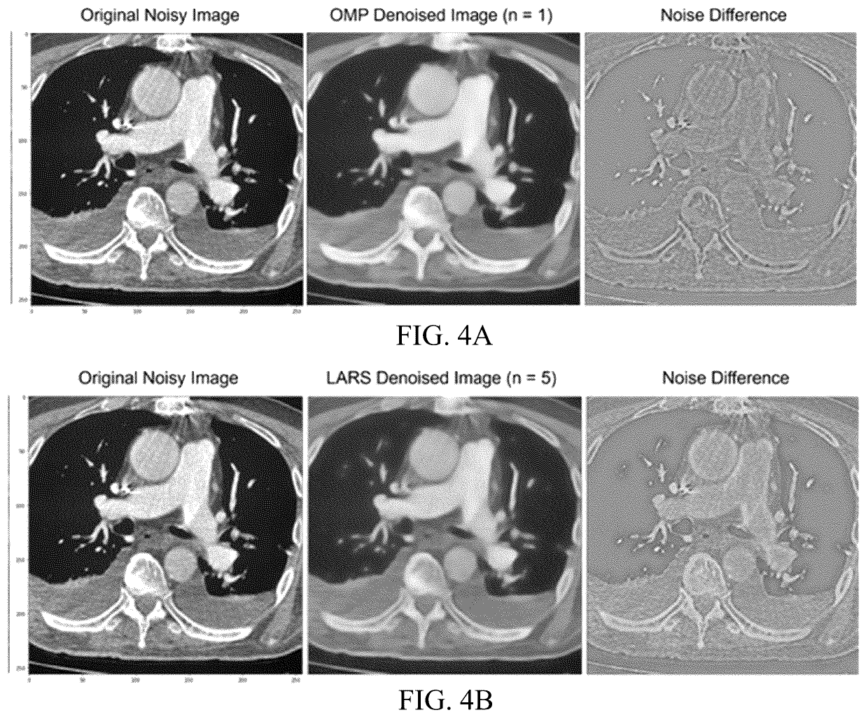

Still referring to FIG. 1, at step 112 the image may be reconstructed. In some embodiments, the overlapping patches may be averaged to reconstruct the image. FIGS. 4A and 4B illustrate the image as reconstructed from denoised patches, as well as the comparative results of denoising patches 110 using OMP (FIG. 4A) and LARS (FIG. 4B). The noise difference between the original noisy image and the denoised image is also plotted. In some examples, step 112 may perform the recombining of denoised patches with an algorithm as shown below.

Recombine denoised patches: enoise patches:
Update patches:
Eₗ · Z;
Reconstruct denoised image:
Reconstructions = X = (λI + Σᵢⱼ Rᵢⱼ^{T}Rᵢⱼ)⁻¹ (λI + Σᵢⱼ Rᵢⱼ^{T}Daᵢⱼ);
Display denoised image

In some examples, each of these now denoised patches undergo summative recombination of the residual data matrices with the associated eigenvalues for each. This provides a resultant denoised image in its original orientation.

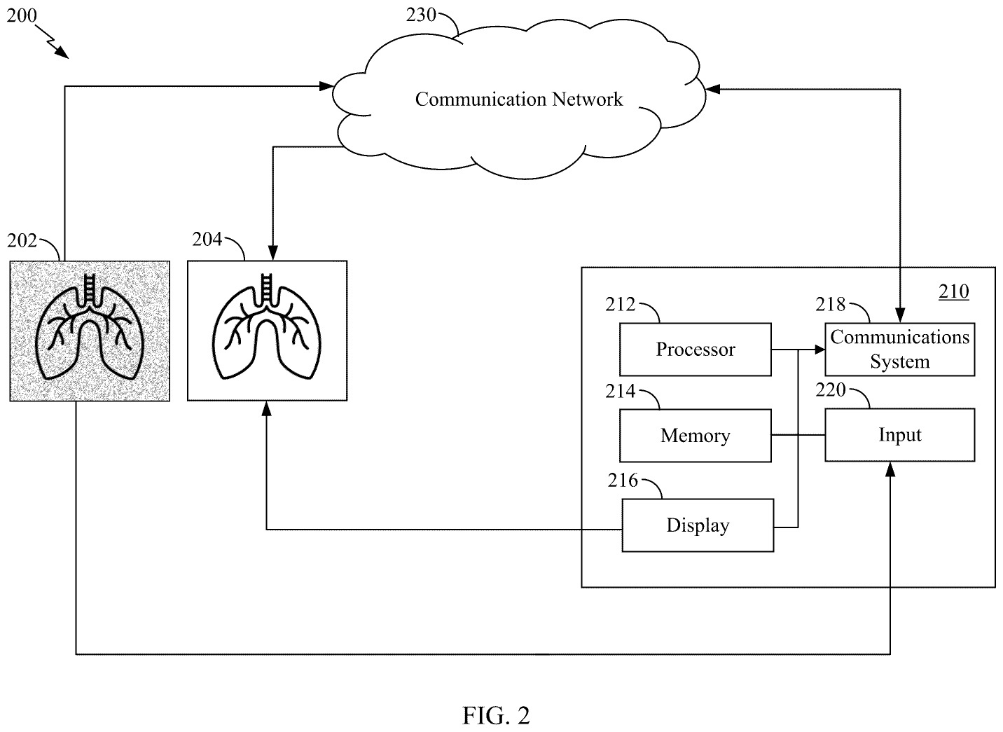

FIG. 2 is a block diagram conceptually illustrating a system for denoising an image. In some examples, a computing device 210 can obtain or receive a medical image 202 including noise, denoise the medical image 202, and produce a denoised medical image 204.

In some examples, the medical image 202 can be produced by a magnetic resonance Imaging (MRI) device, a computed tomography (CT) imaging device, an ultrasound imaging device, an X-ray imaging device, or any other suitable medical imaging device.

In some examples, the computing device 210 can include a processor 212. In some embodiments, the processor 212 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc.

In further examples, the computing device 210 can further include a memory 214. The memory 214 can include any suitable storage device or devices that can be used to store suitable data (e.g., the medical image data, an algorithm to denoise the medical image, the denoised medical image data, etc.) and instructions that can be used, for example, by the processor 212 to preprocess the medical image to transform the image into an image having at least one given characteristic, determine a set of patches from the transformed image, determine a dictionary based upon the set of patches, denoise the set of patches, denoise the medical image by reconstructing the denoise set of patches into a denoised version of the medical image, and present the denoised version of the medical image. The memory 214 can include any suitable volatile memory, non-volatile memory, storage, or any suitable combination thereof. For example, memory 114 can include random access memory (RAM), read-only memory (ROM), electronically-erasable programmable read-only memory (EEPROM), one or more flash drives, one or more hard disks, one or more solid state drives, one or more optical drives, etc. In some embodiments, the processor 212 can execute at least a portion of process 100 or 300 described below in connection with FIG. 1.

In further examples, the computing device 210 can further include a communications system 218. The communications system 218 can include any suitable hardware, firmware, and/or software for communicating information over the communication network 230 and/or any other suitable communication networks. For example, the communications system 218 can include one or more transceivers, one or more communication chips and/or chip sets, etc. In a more particular example, the communications system 218 can include hardware, firmware and/or software that can be used to establish a Wi-Fi connection, a Bluetooth connection, a cellular connection, an Ethernet connection, etc. In some examples, the processor 212 can, via the communications system 218, receive the medical image 202 and transmit the denoised medical image 204 over the communication network 230.

In further examples, the computing device 210 can receive or transmit information (e.g., the medical image 202, the denoised medical image 204, etc.) and/or any other suitable system over a communication network 230. In some examples, the communication network 230 can be any suitable communication network or combination of communication networks. For example, the communication network 230 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 130 can be a local area network, a wide area network, a public network (e.g., the Internet), a private or semi-private network (e.g., a corporate or university intranet), any other suitable type of network, or any suitable combination of networks. Communications links between the communication network 230 and an image source or destination or between the communication network 230 and the communications system 218 can each be any suitable communications link or combination of communications links, such as wired links, fiber optic links, Wi-Fi links, Bluetooth links, cellular links, etc.

In further examples, the computing device 210 can further include a display 216 and/or an input 220. In some embodiments, the display 116 can include any suitable display devices, such as a computer monitor, a touchscreen, a television, an infotainment screen, etc. to display the denoised image 204, or any suitable information associated with the denoised image 204. In further embodiments, the input 220 can include any suitable input devices (e.g., a keyboard, a mouse, a touchscreen, a microphone, etc.) and/or the medical imaging device that can produce the medical image 202.

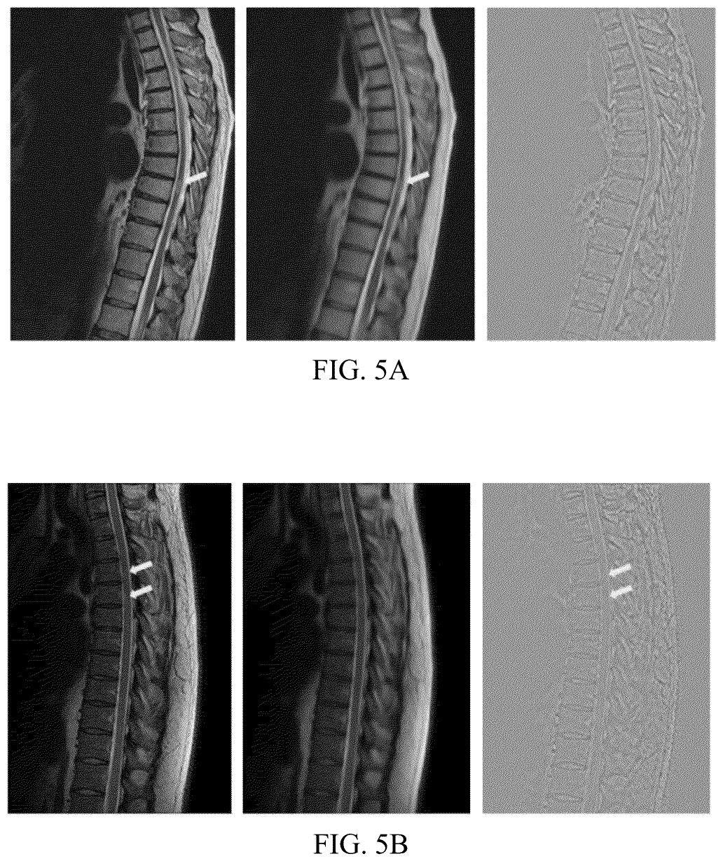

FIGS. 5A and 5B illustrate two MRI images of spinal columns denoised according to various aspects of the present disclosure. In FIG. 5A, after using the denoising method 100, it is apparent that the Lesion persists and was not the result of noisy data. In FIG. 5B, after using the denoising method 100, it is apparent that the lesion effaces and was the result of noisy data. Thus, appropriate diagnosis can be made rapidly, through use of the processes and techniques described herein.

The denoising method 100 provides a lightweight and effective solution to denoising medical images, customized to each individual patient and image and not relying on generalized dictionaries. In some embodiments, part or all of the denoising method 100 may be implemented within a PACS software. In an exemplary embodiment, the denoising method 100 may be implemented as a single “hot-key” function in a PACS application. Thus, diagnostic accuracy and speed may be improved, which can impact the treatment a patient receives.

Various examples of implementations of the concepts and methods of the present disclosure are described below, along with data from experiments conducted to demonstrate the improved performance of these methods. It should be understood from these examples that the methods described herein can be applied and adapted to suit numerous image modalities and scan types.

### EXAMPLE 1

### CT Angiography

### Rapid Personalized Denoising for CT Angiography

Computed tomography pulmonary angiography (CTPA) has become the reference standard for diagnosis of pulmonary embolism (PE); however, these studies often have limitations due to artifacts. Prior denoising algorithms involved universal filtering and/or deep neural networks which lose information or have a high computation cost.

To demonstrate the improved performance of the techniques described herein a study was performed using an example implementation of the present disclosure. In this study, CTPA images (e.g., having a size of, or resized to, 256×256 pixels) were separated into 62,001 overlapping patches of 8×8 and a generalized Lasso problem was minimized to provide sparse representation of the image. Over 500 iterations provided a dictionary of 100 atoms that sparsely encoded the original image patches which was then comparatively denoised using orthogonal matching pursuit (OMP) and least angle regression (LARS). The denoised patches were reconstructed to form a denoised image.

OMP and LARS were able to extract artifacts from the CTPAs with improved visualization of the opacified pulmonary arteries using each images own noise distribution. Training averaged 7.1 seconds with OMP denoising taking 3.9, and LARS denoising, 22.4.

The provided fast and lean solution denoised CTPA based upon the images' unique noise distribution and without external pretraining, transfer learning, or computationally expensive neural networks.

### Denoising Algorithm

The algorithm was constructed using Python 3.10 in Jupyter Notebooks using a single NVIDIA V100 GPU. DICOM key images were saved as JPEG files of 512×512×3. Images were individually uploaded to the notebook and resized to 256×256×1 and converted into a Numpy array. Each image underwent a patch extraction to create 8×8 overlapping, noisy patches. Least angle regression method (LARS) was used to develop an ideal dictionary based upon the noisy patches which solves for the lasso problem with the optimization objective over 500 iterations, such that:

$$min \frac{1}{2 n} {‖ y - Dw ‖}_{1} + α {‖ w ‖}_{1}$$

where n is the number of samples, y is the original noisy image, D is a dictionary which is learned from the given reference patches, w is the projected noiseless image, and α is a sparsity-inducing penalty term for the l₁ norm.

This process produced a dictionary (e.g., the dictionary 300 shown in FIG. 3B) that sparsifies the representations and is used to denoise the 62,001 overlapping patches individually using a greedy pursuit algorithm. A form of K-single value decomposition (K-SVD), Orthogonal Matching Pursuit (OMP) was selected to noise the patches in order to impose the sparset solution, wherein each row of the original image patch is compared to the corresponding dictionary column and only the correlating, sparse atoms are kept as a projection of the denoised image. Images were subsequently reconstructed using the learned dictionary via OMP such that:

α=argim_{α}∥α∥₀⁰s.t.½∥Dα−y∥₂²≤ϵ²

where the dictionary is updated column-by-column via SVD computation, and where ϵ is the error function (difference between the projected sparse representation and the actuage image). Resultant denoised patches are reassembled to produce the entire denoised image. A separate image of the noise was produced to visualize the error removed.

OMP and LARS were able to extract artifact from the CTPAs with improved visualization of the opacified pulmonary arteries using each images' own noise distribution. Training averaged 7.1 seconds with OMP denoising taking 3.9, and LARS denoising, 22.4. Examples of the results of this study are shown in FIG. 4a (OMP) and FIG. 4b (LARS). While both OMP and LARS were used in this study, it should be understood that either of them could be used separately, or a user may be given the choice to use either OMP or LARS for the dictionary learning (or the results of both could be displayed for consideration by the user/radiologist, given the low computational cost and time for denoising). In other words, a system could be programmed to allow a user to specify the Dictionary Learning as OMP or LARS, or both. Then, regardless of the choice for Dictionary Learning, the final model fit can still be done by Lasso optimization for purposes of speed (and in which step accuracy is not as important), hence the system may utilize an L1 norm instead of L0. L0 may still be used in the final denoising in order to provide the sparsest solution.

### EXAMPLE 2

### MRI Detection of Multiple Sclerosis

Multiple Sclerosis (MS) is a severely debilitating disease which requires accurate and timely diagnosis. MRI is the primary diagnostic vehicle; however, it is susceptible to noise and artifact which can limit diagnostic accuracy. A myriad of denoising algorithms have been developed over the years for medical imaging yet the models continue to become more complex.

Accordingly, a study was performed to demonstrate the improved performance of using the techniques described herein, that performs as well or better than existing algorithms yet does not involve the same complexity or computational time/cost. In this study, an embodiment was used that implemented a lightweight algorithm which utilizes an image's inherent noise via dictionary learning to improve image quality without high computational complexity or pretraining, through a process known as orthogonal matching pursuit (OMP).

In this Example section the embodiment is compared to existing traditional denoising algorithms to comparatively demonstrate performance on real noise that would commonly be encountered in a clinical setting. Fifty patients with a history of MS who received 1.5 T MRI of the spine between the years of 2018 and 2022 were retrospectively identified in accordance with local IRB policies. Native resolution 5 mm sagittal images were selected from T2 weighted sequences for evaluation using various denoising techniques including the proposed OMP denoising algorithm. Peak signal to noise ratio (PSNR) and structural similarity index (SSIM) were measured. While wavelet denoising demonstrated an expected higher PSNR than other models, its SSIM was variable and consistently underperformed its comparators (0.94±0.10). The embodiment that utilized the OMP denoising algorithm provided improved performance with greater consistency in terms of SSIM (0.99±0.01) with similar PSNR to non-local means filtering (NLM), both of which were improvements compared to the other comparators (OMP 37.6V2.2, NLM 38.0±1.8). The performance of the OMP denoising embodiment in comparison to traditional models demonstrates clear clinical utility. Given its individualized and lightweight approach, implementation into PACS may be more easily incorporated.

### Introduction

Multiple sclerosis (MS) is a serious and often fatal autoimmune demyelinating disease which affects patients in formative years of their lives, often while building a family or developing their careers. It is estimated that MS impacted approximately 2.8 million individuals in 2020, a troubling diagnosis as it is typically during the stage of a patient's life when they may be developing a family or the next step in their career. The diagnosis of MS depends on the clinical symptomatology but also the imaging findings suggestive of demyelination in the central nervous system (CNS) where patients often deteriorate with varying degrees of disability. Treatment involves immunosuppression which has deleterious consequences and may not always be effective in certain populations. As such, accurate and timely diagnosis are paramount to patients' well-being as well as their future treatment and life planning. To this end, magnetic resonance imaging (MRI) is the primary vehicle of radiologic diagnosis for these patients. Unfortunately, noise in MRI images can mislead diagnosis of subtle MS lesions which may be as small as 3 mm. “Artifact” is considered a general term which incorporates inherent and extrinsic aberrations in the resultant image which includes noise, a signal that is additive to the patient's anatomic scan and may be due to the MRI, the coil, the patient's clothing, or the postprocessing steps. Inherent noise such as Gaussian, thermal, and Rician noise as well as motion artifact can produce perceived increased signal most noticeable in the spinal cord given its smaller relative diameter compared to intracranial structures. This is an important point as spinal lesions are more specific for MS diagnosis than intracranial lesions; therefore, denoising algorithms have the potential to provide improved diagnostic accuracy and resultant planning.

### Methods

A goal of the study was to demonstrate a lightweight denoising algorithm that would learn noise inherent to the input image and use this overcomplete dictionary of noisy patches in order to create a resultant denoised image with improved clarity, and specific to clinical application, improved visualization of lesions or dissolution of artifact. Comparison to previously identified domain filtering and transform algorithms was then performed on the same noisy image with resultant peak signal to noise ratio (PSNR) and structural similarity index (SSIM) reported to provide comparison of denoising and edge preservation.

Performance comparison was made to Gaussian blur, NLM filtering, Wavelet denoising, Bilateral filtering, and Weiner filtering. Gaussian blur is of the lowest complexity and simply iterates a kernel over the image with an implied Gaussian distribution of noise. NLM filtering is a form of Low Rank Approximation (LRA) which uses a weighted nuclear norm minimization (WNNM) using spatial Gaussian weighting, usually providing greater edge preservation. Fast NLM was utilized to optimize computation time where sigma (expected noise distribution) was not provided based upon studies demonstrating minimal PSNR increase at the cost of computational time. In contrast, wavelet transformation computed the estimated noise distribution and utilized the BayesShrink algorithm which assigns and individualized soft thresholding for each wavelet representation. Bilateral filtering involves the use of a normalization factor applied to the summation of an image's space and range weights, in other words, the impact of a pixel neighborhood and its edges' minimum amplitudes, theoretically resulting in improved edge preservation. Finally, Weiner filtering using linear time-invariant (LTI) filtering in order to determine the transfer function of the image given a stationary noise, similar to a sinusoidal frequency filter.

### Algorithm Architecture

Dictionary learning was chosen over a generic DCT overcomplete dictionary to provide individualized denoising that is unique to the image. To create the dictionary, the noisy image was deconstructed into 8×8 overlapping, noisy patches. Least angle regression method (LARS) was used to develop an ideal dictionary based upon the noisy patches which solves the lasso problem with the optimization objective over 500 iterations such that:

$$min \frac{1}{2 n} {‖ y - Dw ‖}_{1} + α {‖ w ‖}_{1}$$

where n is the number of samples, y is the original noisy image, D is a dictionary which is learned from the given reference patches, w is the projected noiseless image, and α is a sparsity-inducing penalty term for the l₁ norm. This process produces an overcomplete dictionary that is used to sparsify the representations. In some examples, this may be done with an algorithm as shown below.

```
N_dict_elements to extract = 100;
alpha = 1;
iterations = 500;
batches = 3
transformation = “Orthogonal Matching Pursuit”;
for i patches:
  Input: noisy patch y, Dictionary A, Support S
  Initialize: k = 0, \hat{x}₀ = 0, r₀ = b− Ax₀, S₀ = Ø;
  For k = k + 1;
    $\text{compute:} E ( i ) = {min}_{z} {‖ {za}_{i} - {r}_{k - 1} ‖}_{2}^{2} , 1 \leq i \leq m ;$
    select i₀ s.t. ∀ 1 ≤ i ≤ m, E(i₀) ≤ E(i) where i₀ = argmax|Aⱼ^{T}rⁱ|;
    update Sₖ : Sₖ₋₁ ∪ {i₀};
    ${\hat{x}}_{k} = {min}_{x} {‖ Ax - b ‖}_{2}^{2} s . t . Supp \{ x \} = {S}_{k} ;$
    update r_{k :} rₖ = b − Axₖ;
  if ||rₖ||₂² ≤ ϵ;
    stop;
  else:
    k = k + 1;
  for patches:
    Fit to extracted patches by minimization of LASSO problem via
    LARS:
    $Z = {min}_{w} \frac{1}{2 N} {‖ y - Xw ‖}_{2}^{2} + α {‖ w ‖}_{1}$
```

Orthogonal Matching Pursuit (OMP) was selected to denoise the patches in order to impose the sparsest solution, wherein each row of the original image patch is compared to the corresponding dictionary column and only the correlating, sparse atoms are kept as a projection of the denoised image. Images were subsequently reconstructed using the learned dictionary via OMP such that

α=argim_{α}∥α∥₀⁰s.t.½∥Dα−y∥₂²≤ϵ²

where the dictionary is updated column-by-column.

### Implementation

Native T2-weighted sequence image slices, having resolution of 256×256-pixels, were obtained and saved as JPEG format from the DICOM files. Select 4 mm slices with the lesion in question were isolated for denoising. Two dimensional (2D) images were used per the algorithm libraries that were employed; however it would also be possible to do the same SVD step in 3D matrices. As the above, a separate dictionary was created beforehand to use as the overcomplete dictionary for OMP, favored over a generic DCT or equivalent dictionary which would not be specific to the images' noise.

```
Initialize: noisy image Y, learned dictionary D, number of training iterations j, Lagrange
multiplier λ;
Extract patches;
Initialize: n_nonzero_coefficients = [symbol]   , reconstructions = Ø, set X = Y;
for I patches:
  Input: noisy patch y, Learned Dictionary D, Support S;
  Initialize: i = 0, j = 0, \hat{x}₀ = 0, r₀ = b− Ax₀, S₀ = Ø;
  for Vᵢⱼ:
    $\text{compute:} {min}_{{a}_{i j}} λ ‖ Y - X ‖ + {\sum }_{ij} {u}_{i j} {‖ {a}_{i j} ‖}_{0} + {\sum }_{ij} {‖ {Da}_{i j} - {R}_{i j} X ‖}_{2}^{2}$
    set: Eₗ = {aᵢⱼ(l)}_{{i,j}∈w}_{ₗ}:
    apply: SVD decomposition Eₗ= UΔV^{T};
    update: columns of U with updated dictionary column d̅ₗ;
    update: coefficient values {aᵢⱼ(l)}_{{i,j}∈w}_{ₗ} for values of V multiplied by Δ(1,1)
Denoised Patch Reconstruction recreates a denoised image to the original resolution without
overlap, such as:
Update patches:
  Eₗ · Z;
Reconstruction denoised image:
  reconstructions = X = (λI + Σᵢⱼ Rᵢⱼ^{T}Rᵢⱼ)⁻¹(λI + Σᵢⱼ Rᵢⱼ^{T}Daᵢⱼ);
```

### Experiment Setup

Fifty patients with a history of MS who underwent an MRI of the spine between the years 2018 and 2021 and whose scans demonstrated noise or artifact as reported by the neuroradiologists were identified retrospectively in accordance with local IRB protocols. Images were captured using a Toshiba 1.5 T and Siemens 1.5 T MRI scanners. Anterior and posterior head coils were combined with the table coils to provide 4 to 5 channels based upon patient size.

In other words, this provides some pre-existing knowledge of the noise to optimize the denoising algorithm. As part of the overcomplete dictionary process, least angle regression (LARS) is used to identify salient features from each noisy patch in order to create the dictionary. Following OMP as described above, the denoised patches are then reconstructed without overlap or compression in order to recreate the original resolution of 256×256.

### Results

Wavelet denoising demonstrated an improved PSNR compared to traditional filtering mechanisms but with lower, inconsistent SSIM (0.94±0.01) which was similar to Gaussian Blur (0.94±0.02); however, OMP denoising maintained an improved SSIM over all algorithms (0.99±0.01). Both NLM and OMP demonstrated increased PSNR in comparison to the other algorithms with the former demonstrating a non-significant increase in PSNR over OMP (p=0.464).

### Discussion

Comparison to previous studies demonstrated a greater performance of the OMP denoising algorithm in terms of denoising and similarity to the original image in terms of edge preservation. While the NLM algorithm demonstrated previously documented edge preservation and thus improved SSIM, OMP denoising provided greater edge preservation and general semblance to the original image. This is an important quantitative aspect to consider in MRI which has inherently lower contrast resolution than CT.

As expected, Gaussian blur demonstrated the lowest performance as it is a low complexity filter assuming a normal distribution of noise. Wavelet transformation demonstrated expected superior PSNR, however, many images lost edge detail resulting in a wide variation is SSIM, often well below the OMP algorithm. Bilateral and Wiener filters demonstrated improved edge preservation as expected with the bilateral filter extracting slightly more noise than its counterpart.

The techniques described herein, including embodiments utilizing OMP denoising, demonstrate a lean, individualized denoising algorithm that does not require pretraining. Wavelet denoising was the only traditional comparator that consistently outperformed OMP in PSNR but with much lower SSIM. Spatial resolution is already limited in MRI in comparison to CT, therefore, any loss of fine detail may impact diagnostic potential of the image despite increased pixel quality.

Given the lightweight nature of the embodiments described herein (e.g., utilizing an OMP denoising algorithm), they could be readily deployed within a Docker container which may be able to integrate easily with PACS versus existing as an inlaid sequence or filter within the Imaging Enterprise system.

| | Gaussian | | Nonlocal | | Wavelet | | Bilateral | | Weiner | | OMP | |
|---|---|---|---|---|---|---|---|---|---|---|---|---|
| | blur (k = 3) | | means | | (σ = 0.1) | | diffusion | | filtering | | denoise | |
| | PNSR | SSIM | PNSR | SSIM | PNSR | SSIM | PNSR | SSIM | PNSR | SSIM | PNSR | SSIM |
| Artifact 1 | 31.8 | 0.93 | 37.7 | 0.97 | 62.7 | 0.95 | 33.8 | 0.92 | 35.5 | 0.96 | 38.8 | 0.99 |
| Artifact 2 | 27.3 | 0.89 | 35.5 | 0.93 | 46.7 | 0.99 | 38.7 | 0.88 | 30.7 | 0.91 | 34.8 | 0.98 |
| Lesion 1 | 33.6 | 0.94 | 38.1 | 0.95 | 57.4 | 0.78 | 34.5 | 0.89 | 35.6 | 0.96 | 38.8 | 0.99 |
| Lesion 2 | 30.6 | 0.96 | 40.8 | 0.98 | 53.7 | 0.98 | 35.0 | 0.96 | 35.0 | 0.97 | 38.3 | 0.99 |

In further embodiments, a user interface may be provided (e.g., for a radiologist or other healthcare professional, or for a patient or researcher). In the user interface, the user may be presented with, or select, a set of original/noisy images. These images may be displayed to the user via a display screen. The interface may offer the user the ability to select from among a number of possible denoising techniques, thus containerizing the algorithms so that they are implemented within a PACS system. Once deployed within a clinical environment, the user may more easily toggle between various denoising approaches for the same image, while limiting issues relating to image transfer, processing resources, and privacy. In some further embodiments, computer vision techniques may be utilized to highlight differences (e.g., actual lesions vs. noise appearing as lesions) between original/noisy image and denoised images per the methods described herein. In yet further embodiments, the interface may be configured to present to the user an indication of which denoising algorithms of a number of possible denoising algorithms (e.g., Gaussian blur, Nonlocal means, Wavelet, Bilateral diffusion, Weiner filtering, CNN-based, etc.) were in consensus in regard to whether a given artifact is a lesion or mark of interest versus merely noise.

| | PSNR | s.d | SSIM | s.d |
|---|---|---|---|---|
| Gaussian blur | 31.7 | 4.1 | 0.94 | 0.02 |
| Nonlocal means | 38.0 | 2.9 | 0.95 | 0.02 |
| Wavelet | 56.9 | 4.9 | 0.94 | 0.10 |
| Bilateral diffusion | 35.5 | 2.2 | 0.90 | 0.03 |
| Weiner filter | 34.1 | 2.7 | 0.96 | 0.02 |
| OMP | 37.6 | 1.7 | 0.99 | 0.01 |

As described above, systems and methods according to various embodiments provide a fast and lean solution to denoise medical images (e.g., MRI, CTPA) based upon the image's unique noise distribution and without external pretraining, transfer learning, or computationally expensive neural networks

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent, publication, and Appendix cited herein is incorporated by reference, as if each such patent or publication were individually incorporated by reference herein.

Various features and advantages of the invention are set forth in the following claims.

What is claimed is:

1. A method for denoising a medical image, comprising:
obtaining a medical image of a subject;
determining a set of noisy patches from the medical image;
determine a dictionary based upon the set of noisy patches by learning a sparse representation of the medical image;
denoise the set of noisy patches to create a set of denoised patches;
denoise the medical image by reconstructing the denoised set of patches into a denoised version of the medical image; and
present the denoised version of the medical image for viewing by a user.

2. The method of claim 1, wherein the dictionary comprises a noise vector incorporated into the dictionary per the noisy patches.

3. The method of claim 1, wherein the noisy patches are denoised using an orthogonal matching pursuit (OMP) algorithm.

4. The method of claim 1, wherein the noisy patches are denoised using a least-angle regression (LARS) algorithm.

5. The method of claim 1, wherein denoising the medical image by reconstructing the denoised set of patches includes using an orthogonal matching pursuit (OMP) algorithm to incorporate the dictionary into a sparse optimization of the medical image, separating noise in the medical image.

6. The method of claim 1, wherein, when reconstructing the denoised set of patches into a denoised version of the medical image, overlapping patches are averaged.

7. The method of claim 1, wherein the medical image is a magnetic resonance imaging (MRI) image.

8. The method of claim 1, wherein the medical image is a computed tomography (CT) image.

9. A system for denoising a medical image, comprising:
a memory; and
a processor communicatively coupled to the memory;
wherein the memory stores a set of instructions which, when executed by the processor, cause the processor to:
obtain a medical image of a subject;
determine a set of noisy patches from the medical image;
determine a dictionary based upon the set of noisy patches by learning a sparse representation of the medical image;
denoise the set of noisy patches to create a set of denoised patches;
denoise the medical image by reconstructing the denoised set of patches into a denoised version of the medical image; and
present the denoised version of the medical image for viewing by a user.

10. The system of claim 9, wherein the dictionary comprises a noise vector incorporated into the dictionary per the noisy patches.

11. The system of claim 9, wherein the noisy patches are denoised using an orthogonal matching pursuit (OMP) algorithm.

12. The system of claim 9, wherein the noisy patches are denoised using a least-angle regression (LARS) algorithm.

13. The system of claim 9, wherein to denoise the medical image by reconstructing the denoised set of patches, the memory stores the set of instructions which, when executed by the processor, cause the processor to: use an orthogonal matching pursuit (OMP) algorithm to incorporate the dictionary into a sparse optimization of the medical image, separating noise in the medical image.

14. The system of claim 9, wherein, when reconstructing the denoised set of patches into a denoised version of the medical image, overlapping patches are averaged.

15. The system of claim 9, wherein the medical image is a magnetic resonance imaging (MRI) image.

16. The system of claim 9, wherein the medical image is a computed tomography (CT) image.
